(19) United States
(12) Patent Application Publication
(10) Pub. No.: US 2008/0268095 A1
(43) Pub. Date: Oct. 30, 2008

(54) Dietary Supplement for the Compensation of Nutritional Deficiency

(76) Inventor: Edmund Clemens Herzog, Sonthofen (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 12/105,991

(22) Filed: Apr. 18, 2008

(30) Foreign Application Priority Data
Apr. 20, 2007 (EP) 07008102.1

(51) Int. Cl. A23L 1/29; A23L 1/302; A23L 1/303; A23L 1/304; A23L 1/305

(52) U.S. Cl. 426/2; 426/72; 426/73; 426/648

(57) ABSTRACT

Dietary supplement which comprises one vegetable ingredient, one grass ingredient, one fruit ingredient and one vitamin. As an option, the dietary supplement additionally comprises one antioxidant, and/or one coencyme, and/or one herb ingredient, and/or one fish ingredient, and/or one nut ingredient, and/or one mineral, and/or one protein, and/or one amino acid, and/or zinc-citrate, and/or curcumin, and/or L-carnetine, and/or taurine. Furthermore a procedure for the production of such a dietary supplement and its use for the production of a medicine to improve the general state of health.

### RELATED APPLICATIONS

This application claims the foreign priority benefit of European patent application no. 07008102.1, titled Dietary Supplement For The Compensation Of Nutritional Deficiency, filed Apr. 20, 2007, the complete disclosure of which is incorporated herein by reference.

### FIELD OF THE INVENTION

The invention concerns a dietary supplement which comprises a vegetable ingredient, a grass ingredient, a fruit ingredient and a vitamin.

### BACKGROUND

Dietary supplements are foods, which contribute to a balanced diet and contain one or several nutrients, e.g. in a concentrated form.

Dietary supplements serve to compensate a deficiency in the supply of important nutrients. Due to the improved supply of nutrients the general condition or rather the general health is improved. The taking of dietary supplements is a prophylactic measure to prevent diseases, but also a measure to support convalescence in case of diseases or rather deficiency symptoms.

Typical ingredients of dietary supplements are plant extracts, mineral extracts, vitamins and/or antioxidants. Vegetable, fruit, and herb ingredients are common plant-based ingredients for the preparation of dietary supplements.

US 2006/0147563 A1 describes a dietary supplement, which comprises a fruit, a vegetable and a herb ingredient as well as minerals and vitamins.

Also the use of proteins as an ingredient of dietary supplements is defined by the state of the technology. WO 00/37087 A1 displays a dietarysupplement, which comprises fruit, vegetables and herbs ingredients as well as vitamins, minerals and proteins (e.g. enzymes).

Also grass components are used as dietary supplements, because grasses are especially rich in dietary fibres and the green parts of the grasses contain a high portion of chlorophyll.

Compositions based on grass ingredients are also used for the external application in the treatment of skin diseases and as a rule contain no further additives (WO 95/06459).

Thus, for an optimal supply with nutrients further dietary supplements, which contain for example fruit, vegetable and herb ingredients as well as vitamins, minerals and enzymes have to be taken.

Dietary supplements based on fruit, vegetable and/or herb ingredients, which contain vitamins, minerals and enzymes are characterised by a low percentage of dietary fibre and contain only small amounts of chlorophyll.

Chlorophyll is structurally similar to the heme molecule, which as coenzyme of the hemoglobin of the red blood cells, binds oxygen molecules of human beings and animals and is responsible for the oxygen transportation.

Chlorophyll which is taken in with food is transferred into heme molecules, which fosters the formation of hemoglobin and the transportation of oxygen. Due to the fact that the green part of grasses contains a high percentage of chlorophyll, grasses are associated with a better formation of blood and a better oxygen transportation. A better oxygen supply of the body, in particular of the brain improves the concentration and helps against listlessness.

In addition to that chlorophyll has an antioxidant character and thus is able to bind and so to neutralise harmful radicals, which protects cells and tissue against damages by reactive radicals.

Due to the character of the chlorophyll to coordinate metal ions, chlorophyll is said to have an importance in the binding and expulsion of heavy metal ions in the gastrointestinal tract.

Dietary fibre which is contained in grasses to a large degree, supports digestion because it swells in the intestine due to its ability to bind water in high amounts and thus exercises pressure on the intestinal wall, which stimulates peristalsis.

In addition to that the swelling of the dietary fibres strengthens the feeling of having had enough in the stomach, without a noteworthy increase of the blood sugar level, because the dietary fibre in the gastrointestinal tract is mainly not yet broken down.

Thus, a diet rich in dietary fibre is especially beneficial for diabetics.

Furthermore, the dietary fibre which is contained in grasses is linked with a cholesterol-lowering effect, that's why the taking of dietary fibre reduces the susceptibility or rather the risk of coronary heart disease and thus for example the risk of myocardial infarctions.

A small part of the dietary fibre is broken down by the intestinal flora. During this fermentation short-chain fatty acids, such as e.g. butyrate, which fights the formation of cancer, are produced. Thus, a diet rich in dietary fibre is linked with a reduction of the risk of intestinal cancer.

Thus, in order to reach an optimal supply with nutrients and an optimal prevention of diseases, or rather support of convalescence, in the case of taking the dietary supplements as described in US 2006/0147563 A1 und WO 00/37087 A1, which do not contain any grass ingredients, it is necessary to take additional dietary supplements, such as for example the taking of dietary fibre.

Furthermore, the known dietary supplements consist of a fixed composition of ingredients, which are directed towards equalisation of a specific deficiency in the nutrient supply. If the need for nutrients changes, an optimal nutrients supply with the known dietary supplements is no longer guaranteed.

As the deficiencies in the supply with single nutrients are also very individual, a flexible compilation of the dietary supplement, according to the individual needs, is necessary for an optimal supply with nutrients. This is not possible with the known dietary supplements, which consist of a fixed composition of ingredients.

The function of the invention is to provide an improved dietary supplement, which enables a better nutrient supply of the organism and thus a better prevention against diseases, an improvement of the general well-being and a better support of the convalescence or rather the healing. Furthermore it is the function of the invention to provide an improved dietary supplement which enables an easy adjustment to individual needs of supply. An additional function of the invention is to provide a production process for an improved dietary supplement as well as the use of the dietary supplement to improve the general well-being or rather state of health.

These functions are ensured by a dietary supplement with the features according to claim 1, a production process for the production of a dietary supplement with the features according to claim 8 and an usage of the dietary supplement with the features according to claim 10.

Appropriate further developments or rather special versions are defined in the independent claims.

### DETAILED DESCRIPTION

The dietary supplement according to the invention comprises a vegetable ingredient, a grass ingredient, a fruit ingredient and a vitamin. Preferentially the dietary supplement comprises at least one additional ingredient, whereas the additional ingredient is chosen from the group consisting of an antioxidant, an coenzyme, a mineral, a protein, an amino acid, zinc-citrate, curcumin, L-carnitine, taurine, a herb ingredient, a fish ingredient and a nut ingredient.

Vegetable according to the invention comprises the plant as a whole or parts of the plant (e.g. root, stalk, leaf, blossom, blossom in the state of seed ripeness or seed). Furthermore the term vegetable comprises the plant or parts of the plant in all their development stages (e.g. seedling or blossom or blossom in the state of seed ripeness).

Preferentially the vegetable ingredient of the dietary supplement is chosen from the group consisting of carrot, pumpkin, fungus, courgette, potato, aubergine, asparagus, artichoke, capsicum, salad, cucumber, fennel, beetroot, radish, black salsify, celery, tomatoe, mangold, cabbage, savoy cabbage, kohlrabi, leek, spinach, cauliflower, broccoli, beans and peas. Preferentially the vegetable ingredient comprises one or several vegetables. Several vegetables according to the invention comprise several different vegetables (e.g. carrot or fungus) or several different species and types of the same vegetable (e.g. in potatoes the types “Agata” or “Innovator”). Even more preferential is when the vegetable ingredient comprises two, three, four, five, six, seven, eight, nine or ten vegetables.

The fungi are chosen in particular from the group consisting of shiitake mushroom, maitake mushroom, Judas's ear, lingzhi, hericium erinaceus, shaggy mane, polyporus umbellatus, porcini, agaricus, oyster mushroom, king trumpet mushroom, bay bolete, cantharellus, pholiota mutabilis, truffles, hedgehog mushroom and giant puffball.

Grass according to the invention comprises plant species which belong to the order of poales. Grass species which belong to the family of poaceae are preferred. Amongst others the most important grain species belongs to the family of poaceae. Furthermore, grass species of the familes cyperaceae and juncaceae, to which the papyrus plant and the rush family belong, are preferred.

Grass is understood here as the complete plant or parts (e.g. root, stalk, leaf, blossom, blossom in the state of seed ripeness or seed) of the plant in all its stages of development (e.g. seedling or blossom or blossom in the state of seed ripeness). The grass ingredient is preferably chosen from the group consisting of corn, barley, millet, oat, spelt, rye, indian corn, wheat, bamboo, lemongrass, sugarcane and rice. The grass ingredient preferably comprises one or several grasses, even more preferred is when the grass ingredient comprises two, three, four, five, six, seven, eight, nine or ten grasses. Several grasses according to the invention comprise several different grasses (e.g. wheat or barley) or several different species and types of the same grass (e.g. with barley for example the types “Birgit” or “Brunhild”).

Fruit according to the invention is understood as the complete plant or parts (e.g. root, stalk, leaf, blossom, blossom in the state of seed ripeness or seed) of the plant in all its stages of development (e.g. seedling or blossom in the state of seed ripeness).

The fruit ingredient of the dietary supplement is preferably chosen from the group consisting of pineapple, currant, deadly nightshade, pomegranate, apple, pear, kiwifruit, banana, orange, mandarin, cherry, raspberry, bilberry, blackberry, gooseberry, apricot, peach, plum, kaki, fig, date, strawberry, mango, lychee, melon, grape, papaya, passion fruit and pomelo. The fruit ingredient preferably comprises one or several fruits, even more preferential is when two, three, four, five, six, seven, eight, nine or ten fruits. Several fruits according to the invention comprise several different fruits (e.g. kiwi or pear) or several different species or types of the same fruit (e.g. with apple for example the types “Golden Delicious” oder “Jonagold”).

The vitamin of the dietary supplement is preferably chosen from the group consisting of Vitamin C, D-alpha-tocopherol (Vitamin E), Vitamin B1 (thiamin), Vitamin B2 (riboflavin), niacin (Vitamin B3), pantothenic acid (Vitamin B5), Vitamin B6 (pyridoxine), Vitamin B12, folic acid (Vitamin B9), biotin (Vitamin H), Vitamin A, Vitamin D und Vitamin K. The dietary supplement preferably comprises of one or several vitamins, even more preferential is with two, three, four, five, six, seven, eight, nine or ten vitamins.

Also derivatives of vitamins are understood as vitamins according to the invention. The vitamin derivatives preferably have the same or an improved effect as the corresponding vitamins. The vitamin derivatives already take effect in the applied form or are preferably chemically altered in the body and take effect in the altered form. Preferred vitamin derivatives are oxidation products or edible salts of the vitamins.

For example the dehydro ascorbic acid or the edible salts of the ascorbic acid such as calcium-, magnesium-, potassium-, or zinc ascorbate are preferred derivatives of Vitamin C (ascorbic acid). Especially preferred derivatives of Vitamin C are calcium- or sodium ascorbate. Another preferred derivative of Vitamin C is Ester-C.

Furthermore the dietary supplement preferably comprises a coenzyme. Coenzymes, amongst them also cofactors and prosthetic groups, are non-protein molecules or metal ions, which are embedded in a protein or are covalently or non-covalently bound to a protein. There are interferences between the terms vitamin and coenzyme, because some vitamins act as coenzymes (e.g. biotin).

Preferably the dietary supplement contains one or several antioxidants. Antioxidants are preferably characterised by their ability to bind free radicals and thus to neutralise them. This makes it possible to reduce or prevent the oxidative damages in cells or tissues which are caused by free radicals.

Preferentially the dietary supplement contains an antioxidant, which is chosen from the group consisting of oligomeric proanthocyanidin, citric acid, carotenoid, beta-caroten, lycopene, flavonoid, lecithin, gallate, lactic acid, ascorbyl palmitate, butylated hydroxyanisole and butylated hydroxytoluene. Preferentially the dietary supplement comprises one or several antioxidants, in even more preferential with two, three, four, five, six, seven, eight, nine or ten antioxidants.

In a preferential version certain vitamins or vitamin derivatives take effect as anitoxidants. Preferred, Vitamin C or Dalpha-tocopherol (Vitamin E) is used as antioxidant.

Preferentially, the dietary supplement comprises a herb ingredient. Herbs are understood as the complete plant or parts (e.g. root, stalk, leaf, blossom, blossom in the sate of seed ripeness or seed) of it in all stages of development (e.g. seedling) of the plant or rather its individual parts (e.g. blossom in the state of seed ripeness). Preferentially, the dietary supplement comprises a herb ingredient, which is chosen from the group consisting of melissa, gentian, rosemary, hibiscus, onion, garlic, cress, oregano, basil, thyme, parsley, coriander, buckwheat, ramsons, mugwort, hypericum, mint, sage, German chamomile, true lavender, woodruff, cinnamon, ginseng, nettle, valeriana, ginger, hop, capsella, caraway, malva, common dandelion, achillea and plantago. Preferentially the herb ingredient comprises one or several herbs, even more preferential is with two, three, four, five, six, seven, eight, nine or ten herbs. Several herbs according to the invention comprise several different herbs (e.g. melissa or rosemary) or several different species or types of the same herb (e.g. with hop for example the types “Nugget” or “Smaragd”).

In a preferential version the dietary supplement comprises a fish ingredient. Fish is understood as the entire fish or parts (e.g. flesh, organs, cartilage or bones) of the fish in all its stages of development. Preferentially, the dietary supplement comprises a fish ingredient, which is chosen from the group consisting of shark, tuna, salmon, mackerel, herring, cod, trout, gadidae, plaice, common carp and pollock. Preferentially, the fish ingredient comprises one or several fish. Even more preferential is when the fish ingredient comprises two, three, four, five, six, seven, eight, nine or ten fish. Several fish according to the invention comprise several different fishes (e.g. shark or trout) or several different species and kinds of the same fish (e.g. with trout for example the species “brown trout” or “rainbow trout”).

Furthermore, the dietary supplement comprises a nut ingredient, if preferred. Nut according to the invention is understood as a plant, whose blossom in the state of seed ripeness is formed in the shape of a nut fruit. Here, a nut comprises the complete plant or parts (e.g. root, stalk, leaf, blossom, blossom in the state of seed ripeness or seed) of the plant in all its stages of development (e.g. seedling) or rather in all stages of development of parts of the plant (e.g. blossom in the state of seed ripeness). Preferentially, the dietary supplement comprises one nut ingredient, which is chosen from the group consisting of walnut, hazelnut, brazil nut, beech-nut, chestnut, almond, coconut, pistachio, cashew nut, nutmeg, peanut and pine nut. Preferentially, the nut ingredient comprises one or several nuts, even more preferential is with one, two, three, four, five, six, seven, eight, nine or ten nuts. Several nuts according to the invention comprise several different nuts (e.g. chestnut or hazelnut) or several different species or kinds of the same nut (e.g. with hazelnut for example the species “common hazel” or “filbert”).

In a preferential version the dietary supplement comprises a mineral. Preferentially, the mineral comprises one or several compounds or one or several salts comprising an element chosen from the group consisting of calcium, phosphorus, magnesium, selenium, zinc, iron, iodine, cobalt, copper, manganese, sodium and sulphur. In particular the mineral comprises a mineral, which is chosen from the group consisting of calcium carbonate, sodium selenate, sodium hydrogencarbonate, magnesium carbonate, potassium iodide, calcium phosphate, zinc oxide, manganese sulphate, sodium chloride, titanium dioxide and potassium chloride. Preferentially, the dietary supplement comprises one or several minerals. Even more preferential is when the dietary supplement comprises two, three, four, five, six, seven, eight, nine or ten minerals.

In a preferential version the dietary supplement comprises a protein. Here, the protein is preferentially extracted from plants or animals. Preferentially, the protein comprises one or several proteins from animal products (e.g. milk protein, whey protein or egg protein). In an alternative version the protein is added to the dietary supplement in the form of plant ingredients or animal ingredients. In a further alternative verion the protein is extracted from micro-organisms. Even more preferential is when preferred, the protein is added to the dietary supplement in the form of an extract of micro-organisms. Even more preferential is when the protein is a yeast extract. Furthermore preferentially the protein comprises a protein hydrolysate. Preferentially, the protein is peptone, tryptone or casein hydrolysate.

Preferentially, the dietary supplement comprises a protein, which is chosen from the group consisting of papain, bromelain, albumin, collagen, milk protein, whey protein and egg protein. Preferentially, the dietary supplement comprises one or several proteins, even more preferential is with two, three, four, five, six, seven, eight, nine or ten proteins.

Preferentially, the dietary supplement furthermore comprises one amino acid. For example, the amino acid is chosen from the group consisting of L-arginine, L-glutamine, L-alanine, L-asparagine, L-asparagine acid, L-cysteine, L-glutamine acid, glycine, L-histidine, L-isoleucine, L-leucine, L-lysine, L-methionine, L-phenylalanine, L-proline, L-serine, L-threonine, L-tryptophan, L-tyrosine, L-valine, L-zelinocystein and L-pyrrolysine. Preferentially, the dietary supplement comprises one or several amino acids, even more preferential is with two, three, four, five, six, seven, eight, nine or ten amino acids.

Furthermore the dietary supplement comprises zinc-citrate, curcumin, Lcarnitine and/or taurine.

Preferentially, the individual ingredients of the dietary supplement (e.g. vegetable ingredient or vitamin) exist in a solid or in a liquid form. Even more preferential is when the ingredients have the condition of powder, flakes, flour, crystals, granulate, aqueous solution, oil and/or syrup. Even more preferential are combinations of ingredients with different form and quality.

Preferentially, the ingredients of the dietary supplement (e.g. vegetable ingredient, herb ingredient, fruit ingredient, protein or amino acid) exist as an extract or rather are extracted. An extract or rather extracting according to the invention means that ingredients are available, which have been enriched or purified (partially and completely) from their natural environment or are pure.

For example the vitamin, the protein or the amino acid of the dietary supplement according to the invention exists in purified form. In an alternative version the vitamin of a fruit, of a vegetable, of a fish, of herbs and/or of a nut has been enriched or purified. In another alternative version the vitamin is contained in a fruit, a vegetable, a herb, a fish and/or a nut ingredient.

Alternatively the protein is added to the dietary supplement in the form of plant or animal extracts. For example bromelain and/or papain is extracted from papaya and/or pineapple.

Arginine and/or L-glutamine, for example, are added to the dietary supplement as rice extract.

Preferentially, vitamin, antioxidant, coenzyme, protein, amino acid, zinc-citrate, curcumin, L-carnitine and/or taurin are produced synthetically or by using means of genetic engineering.

Preferentially, the dietary supplement comprises one basic component, which comprises a multitude of nutrients, which covers the organisms' basic requirements of nutrients and comprises a flexible component, which comprises additional nutrients, which are matched to special needs of an organism.

Even more preferential is when the dietary supplement comprises one basic component and one flexible component, whereas the basic component comprises the ingredients vegetable, grass, fruit, one vitamin and one antioxidant and the flexible component comprises at least one additional ingredient chosen from the group consisting of vegetable, fruit, herbs, fungus, fish, one mineral, one protein, one amino acid, zinc-citrate, curcumin, L-carnitine and taurine. For example the basic component comprises one carrot ingredient, one barley grass ingredient, one pineapple ingredient, one ribes ingredient, one vitamin and one antioxidant, and the flexible component comprises at least one ingredient chosen from the group consisting of pumpkin, melissa, shiitake mushroom, gentian, deadly nightshade, rosemary, hibiscus, pomegranate, maitake mushroom, shark cartilage, one mineral, one protein, one amino acid, zinc-citrate, curcumin, L-carnitine und taurin.

Especially preferred is when the dietary supplement comprises one basic component comprising one carrot ingredient, one barley grass ingredient, one pineapple ingredient, one black currant ingredient, calcium ascorbate, D-alpha-tocopherol, vitamin B1, vitamin B2, niacin, pantothenic acid, vitamin B6, vitamin B12, folic acid, biotin and oligomeric proanthocyanidin and one flexible component, comprising one or several ingredients chosen from the group consisting of pumpkin, melissa, shiitake mushroom, gentian, deadly nightshade, rosemary, hibiskus, pomegranate, maitake mushroom, shark cartilage, calcium carbonate, sodium selenate, papain, bromelain, L-arginine, L-glutamine, zinc-citrate, curcumin, L-carnitine and taurine.

For example the dietary supplement comprises a flexible component, which comprises 1-20, preferred 1-10, especially preferred 10-20, in particularly preferred 10-15, even more preferred 1-8, in particular preferred 1-5, the most preferred 1-3 ingredients, which are chosen from the group consisting of pumpkin, melissa, shiitake mushroom, gentian, deadly nightshade, rosemary, hibiskus, pomegranate, maitake mushroom, shark cartilage, calcium carbonate, sodium selenate, papain, bromelain, L-arginine, L-glutamine, zinc-citrate, curcumin, L-carnitine and taurine. Preferentially, the flexible component comprises one, two, three, four, five, six, seven, eight, nine or ten ingredients chosen from the group consisting of pumpkin, melissa, shiitake mushroom, gentian, deadly nightshade, rosemary, hibiskus, pomegranate, maitake mushroom, shark cartilage, calcium carbonate, sodium selenate, papain, bromelain, L-arginine, L-glutamine, zinc-citrate, curcumin, L-carnitine and taurine.

The portion of the vegetable ingredient in relation to the weight of the dietary supplement for example is, in particular, 12-30%, the portion of the grass ingredient, in particular, 5-15%, the portion of the fruit ingredient, in particular, 15-35%, the portion of the vitamin, in particular, 20-25%, the portion of the antioxidant, in particular, 2-19%, the portion of the herb ingredient, in particular, 2-25%, the portion of the fish ingredient, in particular, 2-7%, the portion of the mineral, in particular, 1-10%, the portion of the protein, in particular, 1-6%, the portion of the amino acid, in particular, 2-12%, the portion of the zinc-citrate, in particular, 4-15%, the portion of the curcumin, in particular, 1-8%, the portion of the L-carnitine, in particular, 4-8% and the portion of the taurine, in particular, 3-8

Furthermore, the invention is directed towards a procedure for the production of a dietary supplement according to the invention. Preferentialy, the ingredients of the dietary supplement are provided with one pharmaceutic carrier. For example, the pharmaceutic carrier is chosen from the group consisting of cellulose, such as carboxymethyl cellulose or micro crystalline cellulose, alginate, agarose, alcohol, water, saline solution, oil, lactose and paraffin. The procedure for the production of the dietary supplement comprises the addition of one or several pharmaceutic carriers, which are added simultaneously and/or one after the other. Preferentially, the mass differences of different flexible components are equalised by varying the portion of the pharmaceutic carrier.

Preferentially, according to the procedure according to the invention, the dietary supplement is provided with one pharmaceutic carrier and is brought in a pharmaceutical form, which is preferably solid. Preferential solid pharmaceutical forms are tablets, powder or capsules, in particular cellulose capsules. In an alternative version the pharmaceutical form is liquid, for example in the form of drops, juice or syrup. In another version the pharmaceutical form is a solid, such as a powder or a tablet, which is suitable for dissolving in a liquid.

Preferentially, the production process of the dietary supplement according to the invention comprises a separate production of the basic component and of the flexible component and a subsequent synthesis of both components and the subsequent addition of the pharmaceutic carrier. In an alternative version the pharmaceutic carrier is added to the basic component and/or to the flexible component before the synthesis of the basic component and of the flexible component occurs. Preferentially, the basic component is produced and segmented for the synthesis with the different flexible components. Alternatively, the ingredients of the basic components and of the flexible component are mingled at the beginning of the production process.

An unblanced diet and an increased amount of stress for example cause a deficient supply of vital nutrients or rather an increased consumption of nutrients. Depending on the basic physical constitution of an organism supply deficiencies occur. So, for example an inefficient absorption and utilisation of certain ingredients of the diet, which is individually very different, causes a supply deficiency. These generated deficiencies in the supply with vital nutrients cause for example deficiency symptoms and probably limit the sense of well being, which can even lead to diseases occurring.

Amongst others the dietary supplement according to the invention serves to improve the general state of health of man and animals. Preferentially, the dietary supplement is used to improve the immune defence, the circulatory function, the venous competence, the drive, the activity, the susceptibility to diseases, enervation, the oxygen supply, the pulmonary function, the wound healing, the digestion, the blood quality, the bone and/or the cartilage structure, the ability to concentrate, blood sugar level, the risk of having a myocardial infarction, the sexual drive, the psyche and/or the resistance against cancer as well as to reduce the susceptibility to headaches, the susceptibility to becoming addicted and/or the disposition to diseases of the struma.

It is known that people who are born under a certain sign of the zodiac often have certain diseases or rather specific weak points of the state of health that occur. People born under the zodiac sign Capricorn in particular have renal, intestine, skin and bone troubles and metabolic anomalies. People born under the zodiac sign Taurus often suffer from a weak bone structure and from head, gastric, intestine or cervical diseases and are prone to struma diseases. People born under the zodiac sign Gemini often have neuropathy, intestine and liver diseases and colds of the thorax organs and a disposition to becoming addicted. Women born under the zodiac sign Gemini suffer above average from hysteria. People born under the zodiac sign Cancer are prone to stomach diseases, intestinal anomalies, psychic diseases and blood diseases and often suffer from mental stress. People born under the zodiac sign Scorpio are prone to infections, renal and rectum diseases, sexual diseases and blood diseases. People born under the zodiac sign Libra have above average renal, head, skin and vascular diseases as well as diseases of the musculoskeletal system and vascular disorders. People born under the zodiac sign Virgo often suffer from liver, spleen and intestinal diseases as well as from disorders of the bone structure and of the digestive juices. People born under the zodiac sign Leo are prone to vascular disorders, infections and gastric and intestinal diseases. People born under the zodiac sign Sagittarius often suffer from neural diseases, muscle tensions in the shoulder and cervical area, headache, sciatica and limb paralysis. People born under the zodiac sign Aries are prone to bone problems and cartilage diseases as well as to neuropathy, intestinal diseases and circulatory disorders. People born under the sign of the zodiac Aquarius more often have diseases of the calf veins, of the nerves, of the heart and of the lung as well as circulatory problems and vascular disorders.

People born under the zodiac sign Pisces are prone to foot diseases, heart, intestinal and respiration diseases and diseases of the bronchi.

In a preferred version of the dietary supplement, the dietary supplement comprises one basic component and one flexible component, whereas the flexible component is adjusted to specific health risks or weak points in the general state of health of beings. Such weak points or rather proneness to diseases for example, correlate with the zodiac sign of a being so that the flexible component is preferably adjusted to the sign of the zodiac under which a person is born.

### EXAMPLES

### Example 1

Dietary supplements with one basic component and one or several flexible components in the form of a cellulose capsule with micro crystalline cellulose as pharmaceutical carrier (2-40 mg per capsule):

Basic Component:

| Ingredients | Contents per Capsule in mg |
|---|---|
| Carrot powder | 30.0-80.0 |
| Barley grass powder | 20.0-70 |
| Pineapple powder | 20.0-70 |
| Black currant powder | 20.0-70 |
| Calcium ascorbate (vitamin Ester C) | 50.0-110.0 |
| D-alpha-tocopherol | 5.0-15.0 |
| Oligomeric proanthocyanidin (OPC) | 10.0-25.0 |
| Vitamin B1 | 0.6-2.2 |
| Vitamin B2 | 0.8-2.4 |
| Niacin (Vitamin B3) | 14.0-22.0 |
| Pantothenic acid (Vitamin B5) | 2.0-10.0 |
| Vitamin B6 | 1.0-3.0 |
| Vitamin B12 (0.1%) | 0.2-1.8 |
| Folic acid (Vitamin B9) | 0.1-0.3 |
| Biotin (Vitamin H) | 0.05-0.2 |

Flexible Component:

| Ingredients | Contents per Capsule in mg |
|---|---|
| Pumpkin seed, ground | 15.0-35.0 |
| Curcumin | 20.0-40.0 |
| Melissa | 30.0-50.0 |
| Shiitake mushroom extract | 15.0-35.0 |
| L-carnitine | 20.0-40.0 |
| Gentian extract | 30.0-50.0 |
| Deadly nightshade | 20.0-40.0 |
| Pomegranate extract | 10.0-30.0 |
| Melissa | 35.0-55.0 |
| Shiitake mushroom extract | 15.0-35.0 |
| Maitake mushroom extract | 15.0-35.0 |
| Melissa | 30.0-50.0 |
| Calcium carbonate | 35.0-55.0 |
| Pomegranate extract | 5.0-25.0 |
| Shark cartilage powder | 15.0-35.0 |
| Zinc-Citrate - 3 Hydrate (32% Zn) | 40.0-60.0 |
| Sodium selenate (0.1% Selen) | 1.0-20.0 |
| Papain | 10.0-30.0 |
| Papain | 10.0-30.0 |
| Bromelain (2000 GDU) | 5.0-25.0 |
| Rosemary leaf powder | 45.0-65.0 |
| L-arginine | 35.0-55.0 |
| Pomegranate extract | 10.0-30.0 |
| Melissa | 15.0-35.0 |
| Pomegranate extract | 40.0-60.0 |
| Taurine | 10.0-30.0 |
| L-glutamine | 10.0-30.0 |
| Zinc-citrate - 3 Hydrate (32% Zn) | 40.0-60.0 |
| Curcumin | 1.0-20.0 |
| Hibiscus-anthocyanin | 10.0-30.0 |
| Zinc-citrate - 3 Hydrate (32% Zn) | 15.0-35.0 |
| Sodium selenate (0.1% Selen) | 1.0-20.0 |
| Maiitake mushroom extract | 30.0-50.0 |
| Calcium carbonate | 30.0-50.0 |
| Bromelain | 1.0-20.0 |
| Taurine | 20.0-30.0 |

### Example 2

Dietary supplement with one basic component, one or several flexible components and micro crystalline cellulose as pharmaceutic carrier in form of a cellulose capsule (95 mg per capsule):

Basic Component:

| Ingredients | Contents per Capsule in mg |
|---|---|
| Broccoli powder | 50.0 |
| Wheatgrass powder | 40.0 |
| Orange powder | 40.0 |
| Raspberry powder | 40.0 |
| Calcium ascorbate (vitamin Ester C) | 80.0 |
| D-alpha-tocopherol | 10.0 |
| Oligomeric proanthocyanidin (OPC) | 15.0 |
| Vitamin B1 | 1.4 |
| Vitamin B2 | 1.6 |
| Niacin (vitamin B3) | 18.0 |
| Pantothenic acid (vitamin B5) | 6.0 |
| Vitamin B6 | 2.0 |
| Vitamin B12 (0.1%) | 1.0 |
| Folic acid (vitamin B9) | 0.2 |
| Biotin (vitamin H) | 0.15 |

Flexible Component and Micro Crystalline Cellulose:

Flexible Component:

| Ingredients | Contents per Capsule in mg |
|---|---|
| Pumpkin seed, ground | 25.0 |
| Curcumin | 30.0 |
| Melissa | 40.0 |

Micro Crystalline Cellulose: 5 mg,

Flexible Component:

| Ingredients | Contents per Capsule in mg |
|---|---|
| Shiitake mushroom extract | 25.0 |
| L-carnitine | 30.0 |
| Gentian extract | 40.0 |

Micro Crystalline Cellulose: 5 mg,

or

Flexible Component:

| Ingredients | Contents per Capsule in mg |
|---|---|
| Deadly nightshade | 30.0 |
| Pomegranate extract | 20.0 |
| Melissa | 45.0 |

Micro Crystalline Cellulose: 5 mg,

or

Flexible Component:

| Ingredients | Contents per Capsule in mg |
|---|---|
| Shiitake mushroom extract | 25.0 |
| Maitake mushroom extract | 25.0 |
| Melissa | 40.0 |

Micro Crystalline Cellulose: 10 mg,

or

Flexible Component:

| Ingredients | Contents per Capsule in mg |
|---|---|
| Calcium carbonate | 45.0 |
| Pomegranate extract | 15.0 |
| Shark cartilage powder | 25.0 |

Micro Crystalline Cellulose: 15 mg,

or

Flexible Component:

| Ingredients | Contents per Capsule in mg |
|---|---|
| Zinc-citrate - 3 Hydrate (32% Zn) | 50.0 |
| Sodium selenate (0.1% Selen) | 10.0 |
| Papain | 20.0 |

Micro Crystalline Cellulose: 20 mg,

or

Flexible Component:

| Ingredients | Contents per Capsule in mg |
|---|---|
| Papain | 20.0 |
| Bromelain (2000 GDU) | 15.0 |
| Rosemary leaf powder | 55.0 |

Micro Crystalline Cellulose: 10 mg,

or

Flexible Component:

| Ingredients | Contents per Capsule in mg |
|---|---|
| L-arginine | 45.0 |
| Pomegranate extract | 20.0 |
| Melissa | 25.0 |

Micro Crystalline Cellulose: 10 mg,

or

Flexible Component:

| Ingredients | Contents per Capsule in mg |
|---|---|
| Pomegranate extract | 50.0 |
| Taurine | 20.0 |
| L-glutamine | 20.0 |

Micro Crystalline Cellulose: 10 mg,

or

Flexible Component:

| Ingredients | Contents per Capsule in mg |
|---|---|
| Zinc-citrate - 3 Hydrate (32% Zn) | 50.0 |
| Curcumin | 10.0 |
| Hibiscus anthocyanin | 20.0 |

Micro Crystalline Cellulose: 20 mg,

or

Flexible Component:

| Ingredients | Contents per Capsule in mg |
|---|---|
| Zinc-citrate - 3 Hydrate (32% Zn) | 25.0 |
| Sodium selenate (0.1% Selen) | 10.0 |
| Maiitake mushroom extract | 40.0 |

Micro Crystalline Cellulose: 25 mg,

or

Flexible Component:

| Ingredients | Contents per Capsule in mg |
|---|---|
| Calcium carbonate | 40.0 |
| Bromelain | 10.0 |
| Taurine | 30.0 |

Micro Crystalline Cellulose: 20 mg.

### Example 3

Dietary supplement with one basic component, one or several flexible components and micro crystalline cellulose as pharmaceutical carrier in form of a cellulose capsule (95 mg per capsule):

Basic Component:

| Ingredients | Contents per Capsule in mg |
|---|---|
| Broccoli powder | 45.0 |
| Rye powder | 50.0 |
| Apple powder | 30.0 |
| Grapes powder | 20.0 |
| Vitamin C | 80.0 |
| D-alpha-tocopherol | 10.0 |
| Beta-carotene | 20.0 |
| Vitamin B1 | 1.6 |
| Vitamin B2 | 1.8 |
| Niacin (vitamin B3) | 16.0 |
| Pantothenic acid (vitamin B5) | 8.0 |
| Vitamin B6 | 3.0 |
| Vitamin B12 (0.1%) | 2.0 |
| Folic acid (vitamin B9) | 0.5 |
| Biotin (vitamin H) | 0.2 |
| Vitamin D | 2.0 |
| Vitamin K | 1.2 |
| Vitamin A | 0.5 |

Flexible Component and micro crystalline Cellulose:

Flexible Component:

| Ingredients | Contents per Capsule in mg |
|---|---|
| Deadly nightshade | 50.0 |
| Curcumin | 40.0 |

Micro Crystalline Cellulose: 5 mg,

or

Flexible Component:

| Ingredients | Contents per Capsule in mg |
|---|---|
| Shiitake mushroom extract | 25.0 |
| L-carnitine | 25.0 |
| Gentian extract | 35.0 |
| Maitake mushroom extract | 20.0 |

Micro Crystalline Cellulose: 8 mg,

or

Flexible Component:

| Ingredients | Contents per Capsule in mg |
|---|---|
| Sodium selenate (0.1% Selen) | 15.0 |
| Pomegranate extract | 30.0 |
| Melissa | 40.0 |

Micro Crystalline Cellulose: 8 mg,

or

Flexible Component:

| Ingredients | Contents per Capsule in mg |
|---|---|
| Shiitake mushroom extract | 20.0 |
| Maitake mushroom extract | 25.0 |
| Melissa | 35.0 |
| Pomegranate extract | 10.0 |
| Shark cartilage powder | 30.0 |

Micro Crystalline Cellulose: 20 mg.

or

Flexible Component:

| Ingredients | Contents per Capsule in mg |
|---|---|
| Pomegranate extract | 40.0 |
| Sodium selenate (0.1% Selen) | 15.0 |
| Bromelain (2000 GDU) | 5.0 |

Micro Crystalline Cellulose: 15 mg,

or

Flexible Component:

| Ingredients | Contents per capsule in mg |
|---|---|
| Zinc-citrate - 3 Hydrate (32% Zn) | 40.0 |
| Sodium selenate (0.1% Selen) | 15.0 |
| Papain | 15.0 |

Micro Crystalline Cellulose: 15 mg,

or

Flexible Component:

| Ingredients | Contents per Capsule in mg |
|---|---|
| Papain | 25.0 |
| Rosemary leaf powder | 45.0 |
| Melissa | 35.0 |
| Hibiscus anthocyanin | 20.0 |

Micro Crystalline Cellulose: 20 mg,

or

Flexible Component:

| Ingredients | Contents per Capsule in mg |
|---|---|
| L-arginine | 40.0 |
| Pomegranate extract | 15.0 |
| Melissa | 20.0 |
| Zinc-citrate - 3 Hydrate (32% Zn) | 45.0 |

Micro Crystalline Cellulose: 15 mg,

or

Flexible Component:

| Ingredients | Contents per Capsule in mg |
|---|---|
| Pomegranate extract | 40.0 |
| Taurine | 25.0 |
| L-glutamine | 25.0 |

Micro Crystalline Cellulose: 15 mg,

or

Flexible Component:

| Ingredients | Contents per Capsule in mg |
|---|---|
| Zinc-citrate - 3 Hydrate (32% Zn) | 45.0 |
| Curcumin | 15.0 |
| Hibiscus anthocyanin | 25.0 |

Micro Crystalline Cellulose: 15 mg,

or

Flexible Component:

| Ingredients | Contents per Capsule in mg |
|---|---|
| Zinc-citrate - 3 Hydrate (32% Zn) | 20.0 |
| Sodium selenate (0.1% Selen) | 15.0 |
| Calcium carbonate | 30.0 |

Micro Crystalline Cellulose: 20 mg,

or

Flexible Component:

| Ingredients | Contents per Capsule in mg |
|---|---|
| Calcium carbonate | 10.0 |
| Bromelain | 20.0 |
| Taurine | 35.0 |
| Maiitake mushroom extract | 40.0 |

Micro Crystalline Cellulose: 25 mg.

### Example 4

Dietary supplement with one basic component and one or several flexible components in form of a cellulose capsule with carboxymethyl cellulose as pharmaceutical carrier.

Basic Component:

| Ingredients | Contents per Capsule in mg |
|---|---|
| Broccoli powder | 45.0 |
| Rye powder | 50.0 |
| Apple powder | 30.0 |
| Hazelnut powder | 20.0 |
| Lycopene | 25.0 |
| Vitamin C | 80.0 |
| Vitamin B1 | 1.6 |
| Vitamin B2 | 1.8 |
| Vitamin B6 | 3.0 |
| Biotin (vitamin H) | 0.2 |
| Vitamin D | 2.0 |
| Vitamin K | 1.2 |
| Vitamin A | 0.5 |

Flexible Component and micro crystalline Cellulose:

Flexible Component:

| Ingredients | Contents per Capsule in mg |
|---|---|
| Buckwheat | 45.0 |
| Curcumin | 40.0 |

Carboxymethyl Cellulose: 5 mg,

or

Flexible Component:

| Ingredients | Contents per Capsule in mg |
|---|---|
| Porcini extract | 15.0 |
| L-carnitine | 20.0 |
| Capsella | 50.0 |

Carboxymethyl Cellulose: 10 mg,

or

Flexible Component:

| Ingredients | Contents per Capsule in mg |
|---|---|
| Potassium iodode | 20.0 |
| Pomegranate extract | 35.0 |
| Melissa | 40.0 |

Carboxymethyl Cellulose: 10 mg,

or

Flexible Component:

| Ingredients | Contents per Capsule in mg |
|---|---|
| Mint extract | 40.0 |
| Sodium selenate (0.1% Selen) | 15.0 |
| L-glutamine | 5.0 |

Carboxymethyl Cellulose: 20 mg,

or

Flexible Component:

| Ingredients | Contents per Capsule in mg |
|---|---|
| Zinc citrate - 3 Hydrate (32% Zn) | 30.0 |
| Sodium selenate (0.1% Selen) | 15.0 |
| Papain | 15.0 |

Carboxymethyl Cellulose: 10 mg,

or

Flexible Component:

| Ingredients | Contents per Capsule in mg |
|---|---|
| Plantago extract | 25.0 |
| Rosemary leaf powder | 25.0 |
| Melissa | 35.0 |
| Hibiscus anthocyanin | 20.0 |

Carboxymethyl Cellulose: 15 mg,

or

Flexible Component:

| Ingredients | Contents per Capsule in mg |
|---|---|
| Ramsons | 40.0 |
| Pomegranate extract | 15.0 |
| Melissa | 20.0 |
| Zinc-citrate - 3 Hydrate (32% Zn) | 10.0 |

Carboxymethyl Cellulose: 10 mg,

or

Flexible Component:

| Ingredients | Contents per Capsule in mg |
|---|---|
| Peptone | 40.0 |
| Taurine | 25.0 |
| L-glutamine | 15.0 |

Carboxymethyl Cellulose: 10 mg,

or

Flexible Component:

| Ingredients | Contents per Capsule in mg |
|---|---|
| Oregano | 35.0 |
| Curcumin | 15.0 |
| Egg protein | 35.0 |

Carboxymethyl Cellulose: 10 mg,

or

Flexible Component:

| Ingredients | Contents per Capsule in mg |
|---|---|
| Zinc citrate - 3 Hydrate (32% Zn) | 15.0 |
| Cinnamon | 25.0 |
| L-alanine | 10.0 |

Carboxymethyl Cellulose: 10 mg,

or

Flexible Component:

| Ingredients | Contents per Capsule in mg |
|---|---|
| Calcium carbonate | 10.0 |
| Woodruff | 30.0 |
| Taurine | 25.0 |
| Maiitake mushroom extract | 40.0 |

Carboxymethyl Cellulose: 20 mg,

or

Flexible Component:

| Ingredients | Contents per Capsule in mg |
|---|---|
| Shiitake mushroom extract | 25.0 |
| L-carnitine | 15.0 |
| Magnesium carbonate | 20.0 |
| Rosemary extract | 40.0 |

Carboxymethyl Cellulose: 8 mg,

or

Flexible Component:

| Ingredients | Contents per Capsule in mg |
|---|---|
| Shiitake mushroom extract | 50.0 |
| German chamomile extract | 60.0 |
| Calcium carbonate | 20.0 |

Carboxymethyl Cellulose: 10 mg,

or

Flexible Component:

| Ingredients | Contents per Capsule in mg |
|---|---|
| Yeast extract | 87.0 |

Carboxymethyl Cellulose: 10 mg,

or

Flexible Component:

| Ingredients | Contents per Capsule in mg |
|---|---|
| Whey protein | 87.0 |

Carboxymethyl Cellulose: 10 mg.

### Example 5

Dietary supplements with one basic component and one or several flexible components in form of a tablet with carboxymethyl cellulose as pharmaceutical carrier:

Basic Component:

| Ingredients | Contents per Capsule in mg |
|---|---|
| Fennel extract | 45.0 |
| Indian corn powder | 50.0 |
| Strawberry powder | 30.0 |
| Oligomeric proanthocyanidin | 25.0 |
| Vitamin C | 80.0 |
| Niacin | 1.6 |
| Pantothenic acid | 1.8 |
| Vitamin B6 | 3.0 |
| Biotin (Vitamin H) | 0.2 |
| D-alpha-tocopherol | 2.0 |
| Vitamin B12 | 1.2 |

Flexible Component and micro crystalline Cellulose:

Flexible Component:

| Ingredients | Contents per Capsule in mg |
|---|---|
| Salvia | 45.0 |
| Hop | 40.0 |
| Papain | 5.0 |

Carboxymethyl Cellulose: 10 mg,

or

Flexible Component:

| Ingredients | Contents per Capsule in mg |
|---|---|
| Porcini extract | 20.0 |
| Manganese sulphate | 5.0 |
| Hypericum | 40.0 |
| Mint extract | 40.0 |

Carboxymethyl Cellulose: 10 mg,

or

Flexible Component:

| Ingredients | Contents per Capsule in mg |
|---|---|
| Calcium carbonate | 10.0 |
| Rosemary | 45.0 |
| Peptone | 40.0 |

Carboxymethyl Cellulose: 10 mg,

or

Flexible Component:

| Ingredients | Contents per Capsule in mg |
|---|---|
| L-glutamine | 5.0 |
| Sodium selenate (0.1% Selen) | 15.0 |
| Ramsons | 40.0 |

Carboxymethyl Cellulose: 15 mg,

or

Flexible Component:

| Ingredients | Contents per Capsule in mg |
|---|---|
| Zinc-citrate - 3 Hydrate (32% Zn) | 20.0 |
| Pomegranate extract | 35.0 |
| Porcini extract | 25.0 |

Carboxymethyl Cellulose: 10 mg,

or

Flexible Component:

| Ingredients | Contents per Capsule in mg |
|---|---|
| Rosemary leaf powder | 20.0 |
| Melissa | 30.0 |
| Hibiscus anthocyanin | 20.0 |
| Zinc-citrate - 3 Hydrate (32% Zn) | 10.0 |

Carboxymethyl Cellulose: 15 mg,

or

Flexible Component:

| Ingredients | Contents per Capsule in mg |
|---|---|
| Pomegranate extract | 20.0 |
| Melissa | 20.0 |
| Zinc-citrate - 3 Hydrate (32% Zn) | 10.0 |

Carboxymethyl Cellulose: 10 mg.

or

Flexible Component:

| Ingredients | Contents per Capsule in mg |
|---|---|
| Taurine | 15.0 |
| L-glutamine | 10.0 |
| Curcumin | 15.0 |

Carboxymethyl Cellulose: 10 mg,

or

Flexible Component:

| Ingredients | Contents per Capsule in mg |
|---|---|
| Oregano | 35.0 |
| Egg protein | 35.0 |
| Plantago extract | 25.0 |

Carboxymethyl Cellulose: 10 mg.

### Example 6

Dietary supplement with one basic component, one or several flexible components and micro crystalline cellulose as pharmaceutical carrier in form of a cellulose capsule (95 mg per capsule):

Basic Component:

| Ingredients | Contents per Capsule in mg |
|---|---|
| Carrot powder | 50.0 |
| Barley grass powder | 40.0 |
| Pineapple powder | 40.0 |
| Black currant powder | 40.0 |
| Calcium ascorbate (vitamin Ester C) | 80.0 |
| D-alpha-tocopherol | 10.0 |
| Oligomeric Proanthocyanidin (OPC) | 15.0 |
| Vitamin B1 | 1.4 |
| Vitamin B2 | 1.6 |
| Niacin (vitamin B3) | 18.0 |
| Pantothenic acid (vitamin B5) | 6.0 |
| Vitamin B6 | 2.0 |
| Vitamin B12 (0.1%) | 1.0 |
| Folic acid (vitamin B9) | 0.2 |
| Biotin (vitamin H) | 0.15 |

Flexible Component and micro crystalline Cellulose:

Flexible Component:

| Ingredients | Contents per Capsule in mg |
|---|---|
| Pumpkinseed, ground | 25.0 |
| Curcumin | 30.0 |
| Melissa | 40.0 |

Micro Crystalline Cellulose: 5 mg

This composition is preferably suitable for people born under the zodiac sign Cancer,

or

Flexible Component:

| Ingredients | Contents per Capsule in mg |
|---|---|
| Shiitake mushroom extract | 25.0 |
| L-carnitine | 30.0 |
| Gentian extract | 40.0 |

Micro Crystalline Cellulose: 5 mg

This dietary supplement is preferably suitable for people born under the zodiac sign Sagittarius,

or

Flexible Component:

| Ingredients | Contents per Capsule in mg |
|---|---|
| Deadly nightshade | 30.0 |
| Pomegranate extract | 20.0 |
| Melissa | 45.0 |

Micro Crystalline Cellulose: 5 mg

This dietary supplement is preferably suitable for people born under the zodiac sign Scorpio,

or

Flexible Component:

| Ingredients | Contents per Capsule in mg |
|---|---|
| Shiitake mushroom extract | 25.0 |
| Maitake mushroom extract | 25.0 |
| Melissa | 40.0 |

Micro Crystalline Cellulose: 10 mg

This dietary supplement is preferably suitable for people born under the zodiac sign Leo,

or

Flexible Component:

| Ingredients | Contents per Capsule in mg |
|---|---|
| Calcium carbonate | 45.0 |
| Pomegranate extract | 15.0 |
| Shark cartilage powder | 25.0 |

Micro crystalline Cellulose: 15 mg

or

Flexible Component:

| Ingredients | Contents per Capsule in mg |
|---|---|
| Zinc citrate - 3 Hydrate (32% Zn) | 50.0 |
| Sodium selenate (0.1% Selen) | 10.0 |
| Papain | 20.0 |

Micro crystalline Cellulose: 20 mg

This composition is preferably suitable for people born under the zodiac sign Taurus,

or

Flexible Component:

| Ingredients | Contents per Capsule in mg |
|---|---|
| Papain | 20.0 |
| Bromelain (2000 GDU) | 15.0 |
| Rosemary leaf powder | 55.0 |

Micro crystalline Cellulose: 10 mg

This composition is particularly suitable for people born under the zodiac sign Libra,

or

Flexible Component:

| Ingredients | Contents per Capsule in mg |
|---|---|
| L-arginine | 45.0 |
| Pomegranate extract | 20.0 |
| Melissa | 25.0 |

Micro crystalline Cellulose: 10 mg

or

Flexible Component:

| Ingredients | Contents per Capsule in mg |
|---|---|
| Pomegranate extract | 50.0 |
| Taurine | 20.0 |
| L-glutamine | 20.0 |

Micro crystalline Cellulose: 10 mg

This composition is particularly suitable for people born under the zodiac sign Aries,

or

Flexible Component:

| Ingredients | Contents per Capsule in mg |
|---|---|
| Zinc-citrate - 3 Hydrate (32% Zn) | 50.0 |
| Curcumin | 10.0 |
| Hibiscus anthocyanin | 20.0 |

Micro crystalline Cellulose: 20 mg

This composition is particularly suitable for people born under the zodiac sign Gemini,

or

Flexible Component:

| Ingredients | Contents per Capsule in mg |
|---|---|
| Zinc-citrate - 3 Hydrate (32% | 25.0 |
| Sodium selenate (0.1% Selen) | 10.0 |
| Maiitake mushroom extract | 40.0 |

Micro crystalline Cellulose: 25 mg

This composition is preferably suitable for people under the zodiac sign Pisces,

or

Flexible Component:

| Ingredients | Contents per Capsule in mg |
|---|---|
| Calcium carbonate | 40.0 |
| Bromelain | 10.0 |
| Taurine | 30.0 |

Micro crystalline Cellulose: 20 mg

This composition is particularly suitable for people born under the zodiac sign Virgo.

1: Dietary supplement, comprises a vegetable ingredient, a grass ingredient, a fruit ingredient and one vitamin and optionally one antioxidant, and/or one coenzyme, and/or one herb ingredient, and/or one fish ingredient, and/or nut ingredient, and/or one mineral, and/or one protein, and/or one amino acid, and/or zink-citrate, and/or curcumin and/or L-carnitine, and/or taurine.

2: Dietary supplement according to claim 1, whereas the vitamin is chosen from the group consisting of vitamin C, D-alpha-tocopherol, vitamin B1, vitamin B2, niacin, pantothenic acid, vitamin B6, vitamin B12, folic acid, biotin, vitamin A, vitamin D, and vitamin K.

3: Dietary supplement to claim 1, whereas the protein is chosen from the group consisting of papain, bromelain, albumin, collagen, milk protein, and egg protein.

4: dietary supplement according to claim 1, whereas the amino acid is chosen from the group consisting of L-argnine, L-glutamine, L-alanine, L-asparagine, L-asparagine acid, L-cysteine, L-glutamine acid, glycin, L-histidine, L-isoleucine, L-leucine, L-lysine, L-methionine, L-phenylalanine, L-proline, L-serin, L-threonine, L-tryptophan, L-tyrosine, L-valine, L-selenocysteine and L-pyrrolysine.

5: dietary supplement according to claim 1, whereas a basic component comprises one carrot ingredient, one barley grass ingredient, one pineapple ingredient, one black currant ingredient, calcium ascorbate, D-alpha-tocopherol, vitamin B1, vitamin B2, niacin, pantothenic acid, vitamin B6, vitamin B12, folic acid, biotin and oligomerice proanthocyanidin, and one flexible component is chosen from the group consisting of pumpkin, melissa, Shiitake mushroom, gentian, deadly nightshade, rosemary, hibiscus, pomegranate, Maitake mushroom, shark cartilage, calcium carbonate, sodium selenate, papain, bromelain, L-arginine, L-glutamine, zinc citrate, curcumin, L-carnitine and taurine.

6: Dietary supplement according to claim 5, whereas the flexible component comprises 1-10 ingredients chosen from the group consisting of pumpkin, Melissa, Shiitake mushroom, gentian, deadly nightshade, rosemary hibiscus, pomegranate, Maitake mushroom, shark cartilage, calcium carbonate, sodium selenate, papain, bromelain, L-arginine, L-glutamine, zinc-citrate, curcumin, L-carnitine and taurine.

7: dietary supplement according to claim 1, whereas, relating to the weight of the dietary supplement, the percentage of the vegetable ingredient is 12-30%, the percentage of the grass ingredient is 5-15%, the percentage of the fruit ingredient is 15-35%, the percentage of the vitamin is 20-25%, the percentage of the antioxidant is 2-19%, the percentage of the herb ingredient is 2-25%, the percentage of the fish ingredient is 2-7%, the percentage of the mineral is 1-10%, the percentage of the protein is 1-6%, the percentage of the amino acid is 2-12%, the percentage of the zinc-citrate is 4-15%, the percentage of the curcumin is 1-8%, the percentage of the L-carnitine is 4-8% and the percentage of the taurine is 3-8%.

8: Procedure for the production of a dietary supplement according to one of the claims 1-7, whereas the ingredients are provided with a pharmaceutical carrier.

9: Procedure for the production of a dietary supplement according to claim 8, whereas the pharmaceutical carrier is chosen from the group consisting of micro crystalline cellulose, carboxmethyl cellulose, alginate, agar, alcohol, water, saline, oil, lactose and paraffin.

10: The use of the dietary supplement according to one of the claims 1-7 for the production of a medicine to improve the general state of health.
